(19) United States
(12) Patent Application Publication
(10) Pub. No.: US 2001/0003854 A1
(43) Pub. Date: Jun. 21, 2001

(54) Mini sliding device

(76) Inventor: Mouton Lee, Taipei Hsien (TW)

Correspondence Address: RABIN & CHAMPAGNE, PC, 1101 14TH STREET, NW, SUITE 500, WASHINGTON, DC, 20005, US

(21) Appl. No.: 09/735,531

(22) Filed: Dec. 14, 2000

(30) Foreign Application Priority Data
Dec. 20, 1999 (TW) 088221646

(51) Int. Cl. E05D 15/04

(52) U.S. Cl. 16/94 R

(57) ABSTRACT

A mini sliding device comprises a track; a sliding member on the track, the sliding member having a loop rail, a central recessed portion, and a pair of opposite recesses at the bottom of either side; a plurality of steel balls between the loop rail and the track for supporting the sliding member on the track; a clip on the central recessed portion; a pair of cycle members for cycling the steel balls around the sliding member, each of the cycle member having a stud on the external side and a projection at the bottom on either side, the projections being inserted into the recesses for securing the cycle members to the sliding member; a substantially n-shaped engagement member having a hole on either vertical side, the studs being inserted into the holes for securing the engagement member to the clip and the cycle members; a pair of dust covers; and a pair of lubricating sponges between the dust covers and the cycle members.

### FIELD OF THE INVENTION

The present invention relates to a mini sliding device with improved characteristics.

### BACKGROUND OF THE INVENTION

Conventionally, a mini sliding member is provided on a track. Sliding member comprises a plurality of steel balls movable on track and a cycle member on either end of sliding member. However, the previous design suffered from several disadvantages. For example, it is difficult to mount steel balls on track due to the small size of sliding member. As a result, the manufacturing cost is relatively high. Further the assembly time is relatively long because cycle members are threadedly secured to the ends of sliding member.

Thus, it is desirable to provide an improved mini sliding device in order to overcome the above drawbacks of prior art.

### SUMMARY OF THE INVENTION

It is an object of the present invention to provide a mini sliding device comprising a track; a sliding member on the track, the sliding member having a loop rail, a central recessed portion, and a pair of opposite recesses at the bottom of either side; a plurality of steel balls between the loop rail and the track for supporting the sliding member on the track; a clip on the central recessed portion; a pair of cycle members for cycling the steel balls around the sliding member, each of the cycle member having a stud on the external side and a projection at the bottom on either side, the projections being inserted into the recesses for securing the cycle members to the sliding member; a substantially n-shaped engagement member having a hole on either vertical side, the studs being inserted into the holes for securing the engagement member to the clip and the cycle members; a pair of dust covers; and a pair of oil sponges for lubricating the steel balls, the oil sponges being engaged between the dust covers and the cycle members.

In one aspect of the present invention, the sliding member is formed by injection molding.

In another aspect of the present invention, the assembly of the sliding member is totally by snapping without employing screws or bolts, thus carrying out a simple quick assembly.

The above and other objects, features and advantages of the present invention will become apparent from the following detailed description taken with the accompanying drawings.

### BRIEF DESCRIPTION OF THE DRAWINGS

FIG. 1 is a perspective view of a mini sliding device according to the invention; and

FIG. 2 is an exploded view of the FIG. 1 device.

### DETAILED DESCRIPTION OF THE PREFERRED EMBODIMENTS

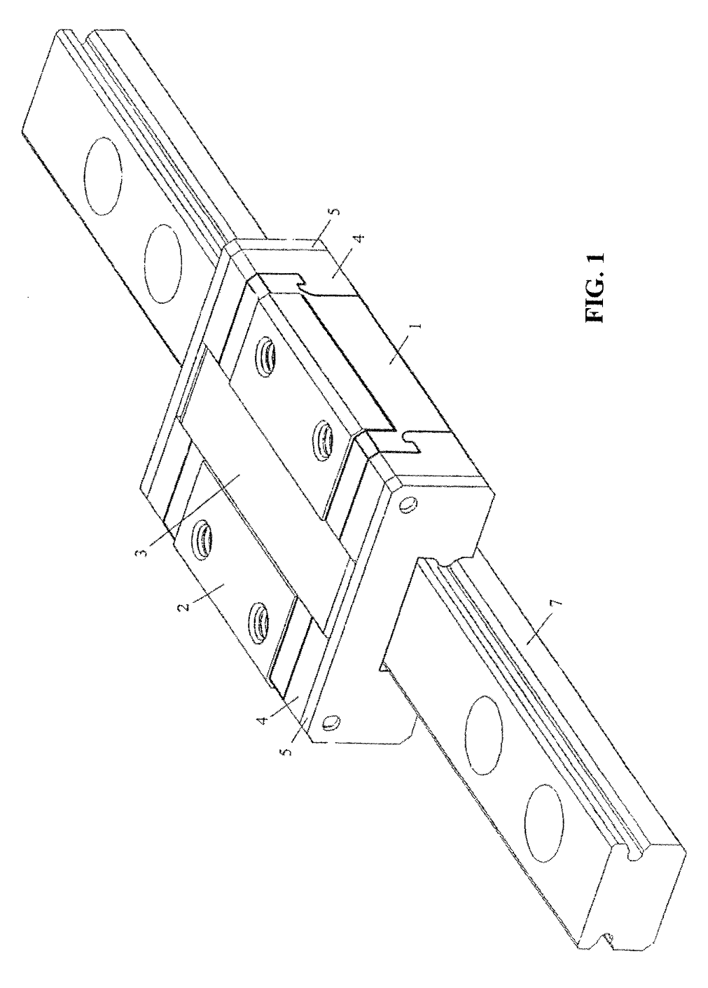

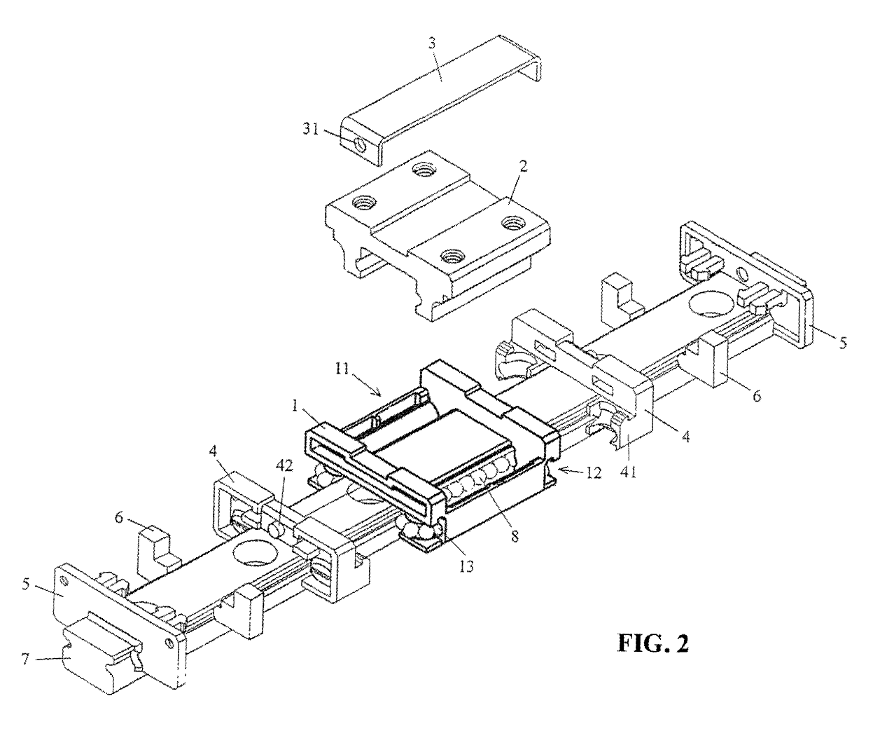

Referring to FIGS. 1 and 2, there is shown a mini sliding device constructed in accordance with the invention comprising a sliding member 1, a clip 2, an engagement member 3, a pair of cycle members 4, a pair of dust covers 5, a pair of oil sponges 6, a track 7 having a predetermined length, and a plurality of steel balls 8. Each of above components will now be described below.

Preferably, sliding member 1 is formed by injection molding. Sliding member 1 is provided on track 7 and has a loop rail 13. The plurality of steel balls 8 are provided between loop rail 13 and track 7 for supporting sliding member 1 to be slidable on track 7. Sliding member 1 also has a central recessed portion 11 and a pair of opposite recesses 12 at the bottom of either side.

Clip 2 is snapped onto the central recessed portion 11.

Cycle members 4 serve as bridge for cycling steel balls 8 around sliding member 1. Each cycle member 4 has a projection 41 at the bottom on either side. Projections 41 are inserted into recesses 12 for securing cycle members 4 to sliding member 1. Each cycle member 4 also has a stud 42 on the external side.

Engagement member 3 is substantially n-shaped and has a hole 31 on either vertical side. Studs 42 are inserted into holes 31 for securing engagement member 3 to clip 2 and cycle members 4. Oil sponges 6 are engaged between dust covers 5 and cycle members 4. Oil sponges 6 are used to lubricate steel balls 8. As shown in FIG. 1, holes 31 and studs 42 are covered by dust covers 5 when the sliding device is assembled. This can prevent holes 31 and studs 42 from disengaging in operation.

While the invention has been described by means of specific embodiments, numerous modifications and variations could be made thereto by those skilled in the art without departing from the scope and spirit of the invention set forth in the claims.

What is claimed is:

1. A mini sliding device comprising:
a track;
a sliding member on said track, said sliding member having a loop rail, a central recessed portion, and a pair of opposite recesses at said bottom of either side;
a plurality of steel balls between said loop rail and said track for supporting said sliding member on said track;
a clip on said central recessed portion;
a pair of cycle members for cycling said steel balls around said sliding member, each of said cycle member having a stud on said external side and a projection at said bottom on either side, said projections being inserted into said recesses for securing said cycle members to said sliding member;
a substantially n-shaped engagement member having a hole on either vertical side, said studs being inserted into said holes for securing said engagement member to said clip and said cycle members;
a pair of dust covers; and
a pair of oil sponges for lubricating said steel balls, said oil sponges being engaged between said dust covers and said cycle members.

2. The mini sliding device of claim 1, wherein said sliding member is formed by injection molding.

3. The mini sliding device of claim 1, wherein said holes and said studs are covered by said dust covers.
